(19) United States
(12) Patent Application Publication
(10) Pub. No.: US 2008/0189245 A1
(43) Pub. Date: Aug. 7, 2008

(54) Accessing data from diverse semiconductor manufacturing applications

(76) Inventors: Joel Fenner, Hillsboro, OR (US); Sutirtha Bhattacharya, Hillsboro, OR (US); Anju Narendra, Beaverton, OR (US)

Correspondence Address: TROP PRUNER & HU, PC, 1616 S. VOSS ROAD, SUITE 750, HOUSTON, TX, 77057-2631, US

(21) Appl. No.: 11/529,802

(22) Filed: Sep. 29, 2006

(51) Int. Cl. G06F 7/06; G06F 17/30

(52) U.S. Cl. 707/3; 707/E17.014

(57) ABSTRACT

Data extraction for semiconductor process analysis may be implemented across multiple databases. A user may select a given level of interest, such as a wafer, a lot, or a die, and may extract specified information across more than one database if desired. The databases may include separate information such as process control information, electrical, and sort test information. Instead of coalescing the databases into one extremely unmanageable database, data can be extracted horizontally across those databases using structured queries.

### BACKGROUND

This relates generally to semiconductor manufacturing operations and, particularly, to tools for the analysis of data from semiconductor processing operations.

In semiconductor processing operations, the components may be semiconductor wafers which, in turn, may be separated into semiconductor dice. Multiple wafers may be processed together as a group of wafers, called a lot. Collections of lots may be called batches. The wafers may be processed through entities which are basically semiconductor processing stations. Examples of such entities may be ion implantation equipment, deposition chambers, etching chambers, and the like.

A wide variety of software applications are used to operate a semiconductor manufacturing facility. In many cases, these applications are incompatible, for example, because they all developed by different sources. If it is desired to correlate data from different applications, those applications may be in different formats, making such correlation difficult.

The need for rapid correlation and collection of data arises because when the semiconductor manufacturing facility is not operating, it is necessary to quickly determine the cause of the problem and to restart the operation. This is because downtime may be extremely expensive, with a large number of wafers sitting idle, while production resources are not being used but, nonetheless, incur costs.

Thus, when something goes wrong, which may be called an excursion, a large amount of money is at stake. Analysis of an excursion may require getting all the manufacturing and test data and understanding correlations between that data. Key questions may include where each lot, wafer, or die was processed and what data is associated with such processing, which may be called lot level traceability, wafer level traceability, and die level traceability, respectively.

Conventionally, lot level analysis has limited effectiveness due to the fact that wafers are often split out from the parent lot during manufacturing and test operations. Thus, a lot identifier that identifies a lot may change over the course of processing. In addition, in test operations, especially after the wafer is cut into dice, the physical meaning of the lot or wafer changes fundamentally and makes tracking by lot or wafer especially challenging.

In many cases, there is a collection of automation systems that have inconsistent data domain formats. Thus, different data domains store data in different databases with different formats. Storage of data by various automation systems may have online transaction processing used cases, as well as offline analytic processing use case requirements. Online transaction processing use cases generally take priority over offline analytical processing.

### BRIEF DESCRIPTION OF THE DRAWING

FIG. 1 is schematic depiction of one embodiment of the present invention;

FIG. 2 is a flow chart for software for developing join parameters in accordance with one embodiment of the present invention;

FIG. 3 is a flow chart for one embodiment of the present invention; and

FIG. 4 is an architectural depiction of one embodiment of the present invention.

### DETAILED DESCRIPTION

Information from a variety of automated systems within a semiconductor manufacturing facility may be joined in a way that enables automatic extraction of data from across those systems. This data extraction may be particularly useful in connection with the analysis of excursions, but may be useful in other cases as well. In some cases, a unified system is provided which enables extraction at various levels within the manufacturing facility. These levels may include the lot, the batch, the wafer, and the die levels to varying degrees of specificity.

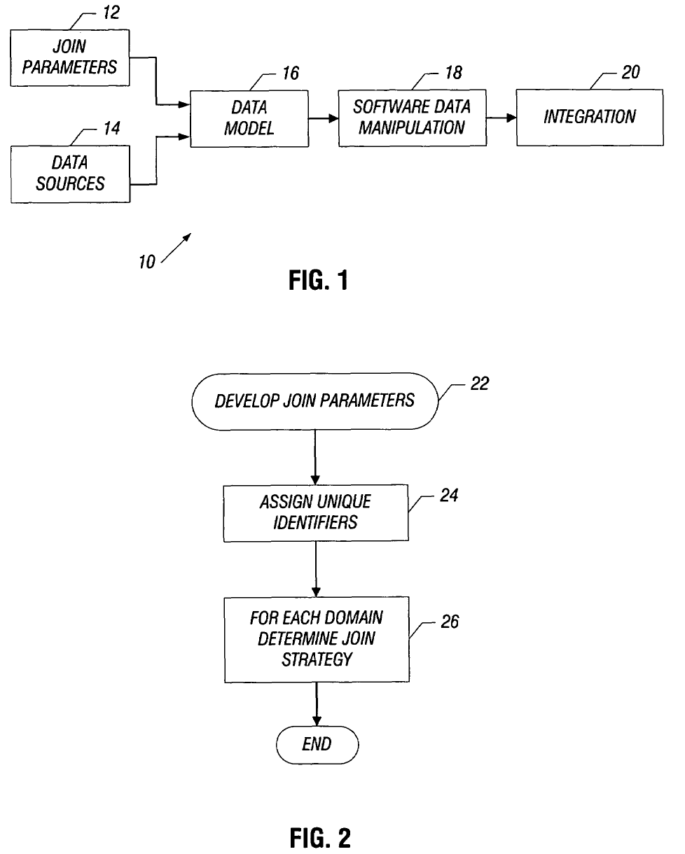

As shown in FIG. 1, a data model 16 is developed from the data sources 14, the data analysis and extraction sequence 10, and join parameters 12. The data sources are basically the sources of data in the form of various automation systems that operate different applications within the semiconductor fabrication facility. The join parameters 12 are the parameters that run across the different data sources and enable information from the different sources to be correlated. Basically, these are identifiers at different levels. For example, identifiers may be available at the wafer level, the batch level, the entity level, the die level, and within the lot level in the form of lot level run identifiers.

The semiconductor manufacturing fabrication and test data of the model may be created by breaking the various sources of data into data domains and then determining how to link those domains together. The number of data domains may expand over time, but may include at least the following data domain models. Statistical process control data primarily consists of metrology data in a matrix plotted on control charts and used to monitor the process. Run to run control data consists of metrology data, after sources other than the statistical process control data, and recommended or actual setting data. Fault detection and classification data consists primarily of trace data during running of process equipment and information on faults, such as detection alarms, classification information, and the like. Work-in-process history contains information on the flow of material through various processing and metro operations, entities, and sub-entities. Entity attributes are typically information on the state of a tool at a given time. The attributes may be developed by counters which indicate the number of wafers since the last preventive maintenance. Preventive maintenance data contains details on the maintenance activities such as the type and identifier of the part changed. The yield data gives inline and end-of-line yields and defect information. Bin test results has binning information that describes whether a die works and, if not, the type of failure. In addition, there may be various parametric test data. Electrical test data has results from various electrical tests, such as current voltage, capacitance voltage, and the like. Facilities data includes various environmental data, such as temperature, pressure, and the like. Assembly test data includes information on testing done after the die is packaged.

After defining domains, such as those described above, the next step in defining the data model may be to understand the levels of the data, as well as the query use cases. The model may have wafer, lot, die, and entity level data. For each level, an identifier needs to be unique or needs to be made to be unique if combined with other keys. This uniqueness may necessitate source database modifications to provide the keys in a fashion amenable to joining the data from the different applications. Additionally, other items that may be useful for joining data across databases may require database modifications.

The run level identifier is different than the conventional run identifier in that a new run level identifier is assigned for each pass through re-work or re-measure. The run level identifier stays the same regardless of re-works or re-measures, so that the data for the overall run at a tool may be correlated. A controller may generate a run level identifier which is then distributed to the various domains.

A process batch identifier may also be assigned. Conventional batch identifiers are re-assigned when a batch goes from a process tool to a metrology tool. If there are a number of metrology steps, a large number of hard to reconcile batch numbers may be assigned. The process batch identifier solves this problem because it is only reassigned when the batch is processed at a process tool.

A unique wafer identifier may also be assigned to each wafer. For example, a twelve digit identifier may be used so that the wafer member is not duplicated over any time period of interest, as in the case of the conventional three digit wafer identifiers. Also, this unique wafer identifier allows tracing of a wafer through split lots.

The strategy for querying and joining each of the key data domains from the level perspective may include the following. At the batch level, the input specification for the query may include a list of process batch identifiers of interest, a list of operations of interest, and a list of domain specific parameters of interest. The join strategy may be the unique batch identifier and the lot level run identifier. At the lot level, the input specification for the query may be the lot identifier list, operation list, and domain specific parameters. The join strategy may include a unique lot identifier and a lot level run identifier. At the wafer level, the input specification of the query includes the wafer identifier list, operation list, and domain specific parameters. The join strategy is unique wafer identifiers and lot level run identifiers.

At the die level the input specification for the query may be the lot or wafer identifier list, optional die identifier list, operation list, and domain specific parameters. The join strategy may include providing unique lot identifiers and lot level run identifiers. At the entry level, the input specification for the query may not be used. The join strategy is that the nearest in time queries between the transaction date and time of the entity level transaction and the transaction date and time of the lot, wafer, or die level transaction in question.

The various data sources may need to be modified in some cases. Generally, full wafer identifiers are provided pursuant to specification and may be scribed on the wafer. Identifiers for batch, lot, entity, and die can be made unique by convention, but they vary by semiconductor manufacturer. All of these identifiers need to be consistent. The run identifier is a unique identifier when paired with a particular run of a lot through an operation. However, the run identifier is reset each time a lot is introduced at a tool. The run identifier is useful for distinguishing re-work and re-measures from original passes of the lot through the tool. It may be used across databases to join these kind of results.

Thus, referring to FIG. 2, the join parameters may be developed using software, as indicated at 22. At least a unique wafer identifier is assigned (block 24) and used by each of the domains. However, advantageously, domains may also use at least one of the process batch identifier and run level identifier. If translation is needed, translation may be provided.

For each domain, a join strategy is developed as indicated in block 26. Examples of potential join strategies include nearest in time join, lot-wafer-die join, run level identifier, process batch identifier, or wafer number join. The nearest in time join looks at an entity attribute or preventative maintenance. It asks when was the last entity attribute or preventative maintenance done on a tool. This is then tied back into an appropriate entity such as a lot, wafer, or die. It then looks at what lots ran under the changed condition. It may use SQL software to find the last value communicated, looking for that last value in a time window of a given duration. In a lot-wafer-die join, the data for the lot, wafer, and die are tied together and used to join the data together. Finally, a process batch identifier, a run level identifier, and/or a wafer identifier may be utilized to join the data across the different domains. As a result, the data model (FIG. 1, block 16) may be developed from the join parameters 12 and the data sources 14.

Once the data model is developed, the data may be manipulated (block 18) and integrated (block 20).

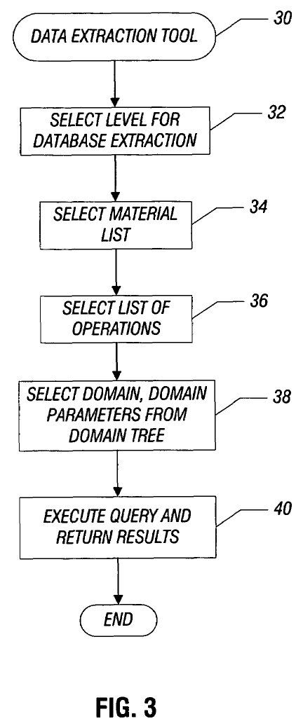

Referring to FIG. 3, a data extraction tool 30 may be used to extract data across a number of different data domains as part of the integration sequence. Initially, the user selects the level (block 32) for database extraction. The selected level may be the batch, lot, wafer, or die level. Then, the user selects from a material list as indicated in block 34. This may be done by manual entry, extraction from previously saved material list files, or by pre-fetching in a query and a database. Pre-fetches may be useful for allowing the user to more easily specify the material, such as the last five days of material through operations X or through tool Y. Next, the user selects a list of operations as indicated in block 36. This may be a selection from a pre-fetch list of all the possible operations. Thereafter, the user selects the domain and the domain parameters, for example, from a domain tree as indicated in block 38. In some cases, the configured query selection or criteria may be modified for any given domain. Finally, as indicated in block 40, the query is executed and the results are returned.

The software automatically operates across the domain joined query by collecting the configured query information for the specified domain queries and by collecting the configured relevant information across domain join conditions. Instead of simply creating one giant database, the required information is actually extracted from a number of different domains or databases.

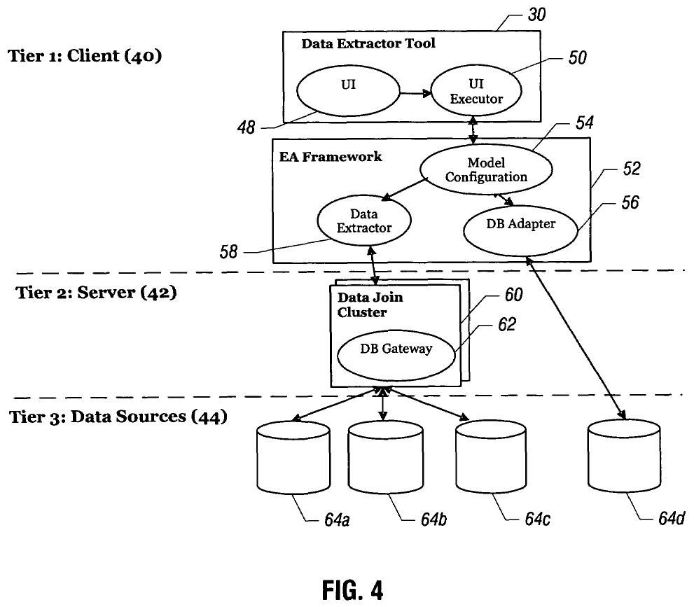

Referring to FIG. 4, the data extraction architecture may be arranged in a three-tier client server model in one embodiment. The highest level is the client 40. The client 40 may be an individual user's client processor-based system which includes thereon the data extraction tool 30, as well as the user interface 48 and the user interface executor 50. It may also include the engineering analysis framework 52 which includes a data extractor 58. The extractor 58 is a subsystem for extracting and joining data from multiple data domains. A model configuration subsystem 54 manages metadata for the engineering analysis framework and handles domain configurations for engineering analysis applications such as query models and parameter models. The database adapter 56 is a subsystem for handling translation of relational data formats into generic schema of the engineering analysis framework database indicated in tier 3, data sources 44.

The next tier is the server tier 42. It includes a data join cluster 60 with a database gateway that is a data join solution for query optimization over multiple databases.

Tier 3 includes the data sources 44 domains. This may include, for example, the domains for sort and electrical test data, a database for persisting metadata configuration information, a data source for work in process, a data source for advance process control, and other process control data as already outlined.

References throughout this specification to “one embodiment” or “an embodiment” mean that a particular feature, structure, or characteristic described in connection with the embodiment is included in at least one implementation encompassed within the present invention. Thus, appearances of the phrase “one embodiment ” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. a method comprising:
extracting information for engineering analysis of a semiconductor processing operation across a plurality of databases.

2. The method of claim 1 including extracting information from a database including process control information and another database including work in process history information.

3. The method of claim 1 including extracting information from at least two databases including at least two of the following: work in process history information, process control information, sort data, or electrical test data.

4. The method of claim 1 including developing a unique wafer identifier to be used by at least two different databases.

5. The method of claim 1 including developing a unique run level identifier that identifies a run including re-working or re-measuring.

6. The method of claim 1 including providing a process batch identifier that changes when a new process operation is done and not when a metrology operation is done.

7. The method of claim 1 including enabling the selection of a level for data extraction including at least one of a lot level, a wafer level, or a die level.

8. The method of claim 1 including enabling the selection of a particular database for data extraction.

9. The method of claim 1 including providing a list of material selections to select for data extraction across at least two domains.

10. The method of claim 1 including allowing the selection of one of at least two data join strategies.

11. A computer readable medium storing instructions to cause a processor-based system to:
extract information for engineering analysis of a semiconductor processing operation across a plurality of databases.

12. The medium of claim 11 further storing instructions to extract information from a database including process control information and from another database including work in process history information.

13. The medium of claim 11 further storing instructions to extract information from at least two databases including at least two of the following: work in process history information, process control information, sort data, or electrical test data.

14. The medium of claim 11 further storing instructions to develop a unique way for an identifier to be used by at least two different databases.

15. The medium of claim 11 further storing instructions to develop a unique run level identifier to identify a run including re-working or re-measuring.

16. The medium of claim 11 further storing instructions to provide a process batch identifier that changes when a new process operation is done and not when a metrology operation is done.

17. The medium of claim 11 further storing instructions to enable the selection of a level for data extraction including at least one of a lot level, a wafer lever, or a die level.

18. The medium of claim 11 further storing instructions to enable the selection of a particular database for data extraction.

19. The medium of claim 11 further storing instructions to provide a list of material selections to select for data extraction across at least two domains.

20. The medium of claim 11 further storing instructions to allow the selection of one of at least two data join strategies.

21. A system comprising:
a data extraction tool to extract information for engineering analysis of a semiconductor processing operation across a plurality of databases; and
a database adaptor to translate information from different databases to a generic schema.

22. The system of claim 21 coupled to a plurality of databases.

23. The system of claim 22 including databases for at least two of work in process history information, process control information, sort data, and electrical test data.

24. The system of claim 21 wherein data can be obtained from more than one database in the form of a run level identifier that identifies a run as including re-working or re-measuring.

25. The system of claim 21 wherein said data extraction tool includes a unique wafer identifier that is used in at least two different databases.
